(19) United States
(12) Patent Application Publication
(10) Pub. No.: US 2026/0116167 A1
(43) Pub. Date: Apr. 30, 2026

(54) VEHICLE FRAMEWORK STRUCTURE

(71) Applicant: TOYOTA JIDOSHA KABUSHIKI KAISHA, Toyota-shi (JP)

(72) Inventor: Daisuke MOTOI, Sanda-shi (JP)

(21) Appl. No.: 19/325,530

(22) Filed: Sep. 11, 2025

(30) Foreign Application Priority Data
Oct. 24, 2024 (JP) 2024-187721

(51) Int. Cl. B60K 1/04; B62D 21/02; H01M 50/242; H01M 50/249; H01M 50/264

(52) U.S. Cl. CPC B60K 1/04; B62D 21/02; H01M 50/242; H01M 50/249; H01M 50/264; B60K 2001/0438; H01M 2220/20

(57) ABSTRACT

A vehicle framework structure, includes a framework member including: a hollow main body portion provided at a vehicle width direction end part and extending in a vehicle front-rear direction; and a partition part provided inside the main body portion and dividing an inner space of the main body portion into upper and lower parts, in which the partition part connects an outer wall positioned at a vehicle width direction outer side, and an inner wall positioned at a vehicle width direction inner side, of the main body portion, and a vehicle width direction inner side of the partition part is formed with a greater thickness in a vehicle vertical direction than a vehicle width direction outer side of the partition part.

### CROSS-REFERENCE TO RELATED APPLICATION

This application is based on and claims priority under 35 USC 119 from Japanese Patent Application No. 2024-187721, filed on Oct. 24, 2024, the entire disclosure of which is incorporated by reference herein.

### BACKGROUND

### Technical Field

The present disclosure relates to a vehicle framework structure.

### Related Art

Japanese Patent Application Laid-open (JP-A) No. 2006-168594 discloses a reinforcement structure of a skeleton frame including a side sill configuring a skeleton frame of a vehicle. Specifically, the side sill (framework member) described in JP-A No. 2006-168594 includes a hollow outer material and a reinforcement disposed inside the outer material, and by making the rigidity at the inside of the reinforcement higher than at the outside, the reinforcing effect of the side sill is increased.

However, in the structure disclosed in JP-A No. 2006-168594, since the structure is such that the outside of the side sill (framework member) is deformed between a cross member and a barrier during a side-on collision of the vehicle, when a collision load is input at a position at which no cross member is disposed, there is a possibility that the framework member will be locally changed without sufficiently absorbing the collision load.

### SUMMARY

The present disclosure provides a vehicle framework structure that enables a framework member to be locally deformed, even in cases in which a collision load has been input at a position at which no cross member is disposed.

A vehicle framework structure according to a first aspect includes a framework member including: a hollow main body portion provided at a vehicle width direction end part and extending in a vehicle front-rear direction; and a partition part provided inside the main body portion and dividing an inner space of the main body portion into upper and lower parts, in which the partition part connects an outer wall positioned at a vehicle width direction outer side, and an inner wall positioned at a vehicle width direction inner side, of the main body portion, and a vehicle width direction inner side of the partition part is formed with a greater thickness in a vehicle vertical direction than a vehicle width direction outer side of the partition part.

In the vehicle framework structure according to the first aspect, a framework member including a hollow main body portion and a partition part is included, and the main body portion is provided at a vehicle width direction end part and extends in a vehicle front-rear direction. Further, the partition part is provided inside the main body portion, and an internal space of the main body portion is divided into upper and lower parts by the partition part. Here, the partition part connects the outer wall of the main body portion, positioned at the vehicle width direction outer side, and the inner wall, positioned at the vehicle width direction inner side, in the vehicle width direction. As a result, a collision load input to the outer wall at the time of a side-on collision of the vehicle is transmitted to the inner wall via the partition part. Since the wall thickness at the vehicle width direction inner side of the partition part is thicker in the vehicle vertical direction than at the vehicle width direction outer side of the partition part, the vehicle width direction outer side with a relatively thin wall thickness can collapse and absorb collision energy. Further, owing to the portion of the partition part at the vehicle width direction inner side that is thicker being bent and changed without collapsing, local deformation of the framework member can be suppressed.

A vehicle framework structure according to a second aspect is the first aspect, in which: the partition part includes an upper partition wall disposed at an upper part of the main body portion and a lower partition wall disposed at a lower part of the main body portion, the upper partition wall and the lower partition wall are provided with a change part, at which the thickness, changes, further toward the vehicle width direction outer side than a vehicle width central part, and the change part of the upper partition wall and the change part of the lower partition wall are connected by a vertical connection wall extending in the vehicle vertical direction.

In the vehicle framework structure according to the second aspect, the partition part includes an upper partition wall and a lower partition wall. Further, change parts at which the thickness changes are provided further toward the vehicle width direction outer side than a vehicle width direction center part of the upper partition wall and the lower partition wall, and the change part of the upper partition wall and the change part of the lower partition wall are connected by a vertical connection wall extending in the vehicle vertical direction. This enables the region as far as the change portion to be effectively collapsed and absorb collision energy, and further, connecting the change portions with the vertical connection wall enables the collision load to be dispersed in a region further toward the vehicle width direction inner side than the change portions.

A vehicle framework structure according to a third aspect is the second aspect, in which: the framework member is provided at respective vehicle width direction sides of a vehicle, one of the framework members and another of the framework members are connected by a cross member extending in the vehicle width direction, and a ridge line of the cross member is provided at the same height as the upper partition wall.

In the vehicle framework structure according to the third aspect, a framework member at one vehicle width direction side and a framework member at another vehicle width direction side are connected by a cross member. Further, since the ridge line of the cross member is provided at the same height as the upper partition wall, a collision load input to the framework member during a side-on collision is transmitted to the ridge line of the cross member via the upper partition wall. This enables a collision load to be effectively transmitted to the non-collision side, and enables deformation of the vehicle body to be suppressed.

A vehicle framework structure according to a fourth aspect is the third aspect, in which: a lower end of the cross member is attached to a battery case housing a battery, and the lower end of the cross member and the lower partition wall are disposed at the same height.

In the vehicle framework structure according to the fourth aspect, because the lower end of the cross member is attached to the battery case, compared to a structure in which an upper face of a battery case is used as a floor panel and a dedicated floor panel is provided, a wider installation space for a battery can be secured. Further, since the lower end of the cross member and the lower partition wall are at the same height, a collision load is transmitted to the lower end of the cross member via the lower partition wall.

A vehicle framework structure according to a fifth aspect is the fourth aspect, in which: a fastening hole at which the battery case is fastened is formed at the framework member, and the fastening hole is provided further toward the vehicle width direction inner side than the vertical connection wall.

In the vehicle framework structure according to the fifth aspect, since the fastening hole is provided further toward the vehicle width direction inner side than the vertical connection wall, a fastening portion between the framework member and the battery case can be protected during a side-on collision.

As explained above, according to the vehicle framework structure according to the present disclosure, even in cases in which a collision load has been input at a position at which no cross member is disposed, the framework member can be locally deformed.

### BRIEF DESCRIPTION OF THE DRAWINGS

Exemplary embodiments of the present disclosure will be described in detail based on the following figures, wherein:

FIG. 1 is a schematic plan view illustrating a framework of a vehicle to which a vehicle framework structure according to a first exemplary embodiment is applied;

FIG. 2 is an enlarged cross-section taken along line 2-2 in FIG. 1; and

FIG. 3 is an enlarged cross-section of relevant portions illustrating the rocker of FIG. 2 in an enlarged manner.

### DETAILED DESCRIPTION

Explanation follows regarding a vehicle framework structure according to an exemplary embodiment, with reference to the drawings.

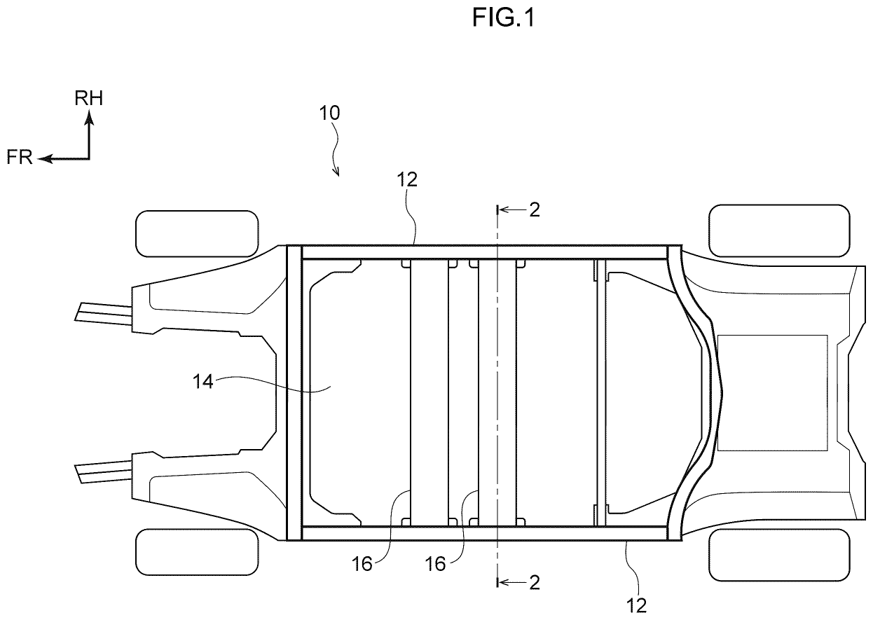

FIG. 1 is a schematic plan view illustrating a framework of a vehicle 10 to which a vehicle framework structure according to an exemplary embodiment is applied. Note that in the drawings, the arrow FR, the arrow UP, and the arrow RH respectively indicate the vehicle frontward direction, the vehicle upward direction, and the vehicle rightward direction of the vehicle 10. Unless specifically stated otherwise, in the following explanation, reference to the front and rear, up and down, and left and right directions refers to front and rear in the vehicle front-rear direction, up and down in the vehicle up-down direction, and left and right in the vehicle left-right direction (width direction), respectively.

As illustrated in FIG. 1, a vehicle 10 of the present exemplary embodiment includes rockers 12 serving as a left and right pair of framework members. The rockers 12 are provided at both vehicle width direction sides of the vehicle 10, and each extends in the vehicle front-rear direction.

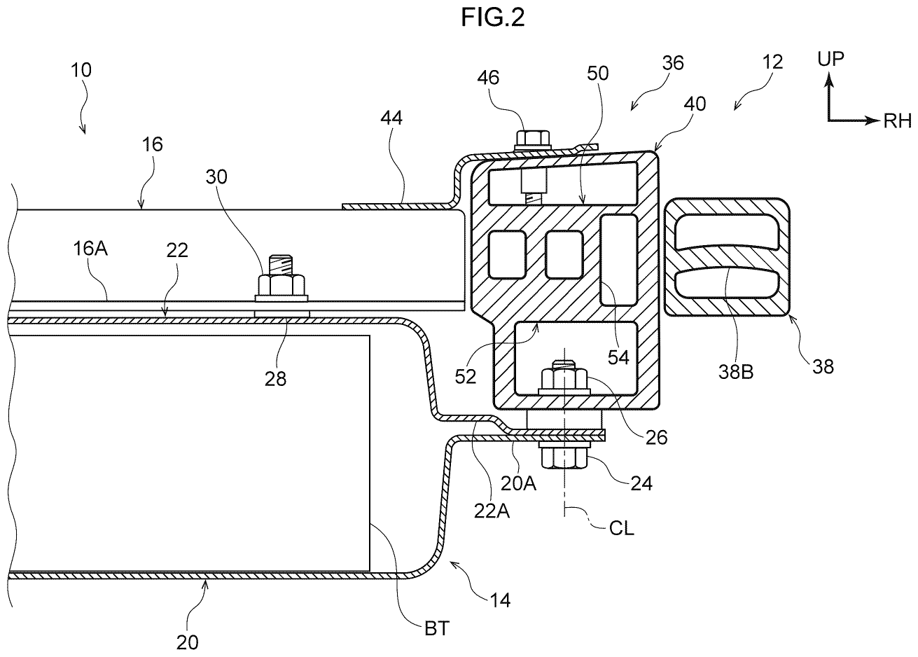

A battery case 14 is disposed between the left and right rockers 12. The battery case 14 is a case that protects a battery BT (see FIG. 2) housed inside the case. Details of the battery case 14 will be described later.

Across member 16 is provided at an upper surface of the battery case 14. In the present exemplary embodiment, as an example, two cross members 16 are disposed, at the front and rear, and each cross member 16 extends in the vehicle width direction. A seat, not illustrated in the drawings, configuring a driver seat, a passenger seat, or the like is attached to the cross member 16.

FIG. 2 is an enlarged cross-section taken along line 2-2 in FIG. 1, illustrating an enlarged state thereof. As illustrated in FIG. 2, the battery case 14 is disposed below the floor of the vehicle 10, and is configured including a case lower 20 and a case upper 22.

The case lower 20 is formed with a substantially hat-shaped cross-section that is open at the vehicle upper side as viewed from the vehicle front-rear direction, and a lower side flange 20A is formed at both vehicle width direction end portions of the case lower 20. Further, the case upper 22 is formed with a substantially hat-shaped cross-section that is open at the vehicle lower side as viewed from the vehicle front-rear direction, and an upper side flange 22A is formed at both vehicle width direction end portions of the case upper 22. The lower side flange 20A and the upper side flange 22A are fastened together by a bolt 24 in an overlapping state. The bolt 24 is screwed to a nut 26 provided at a first energy absorption member 36 configuring the rocker 12.

A battery BT is housed in the battery case 14. The battery BT is configured so as to be capable of supplying electric power to a drive source of the vehicle 10, such as a motor, not illustrated in the drawings.

A cross member 16 is provided above the case upper 22 of the battery case 14. The cross member 16 is formed with a substantially hat-shaped cross-section that is open at the vehicle lower side as viewed from the vehicle width direction, and a flange 16A is formed at each front and rear end part of the cross member 16.

The flange 16A of the cross member 16 is overlapped with the case upper 22 of the battery case 14, and is fastened to the battery case 14 by a stud bolt 28 and a nut 30. There is no particular limitation on fastening portions between the cross member 16 and the battery case 14, and they are fastened at four locations at regular intervals along the vehicle width direction, for example.

Explanation follows regarding details of the rocker 12, which is a relevant portion of the present disclosure.

The rocker 12 is mainly configured including a first energy absorption member 36 and a second energy absorption member 38. The rocker 12 is configured including a rocker inner panel and a rocker outer panel, not illustrated in the drawings, serving as an outer shell, and the first energy absorption member 36 and the second energy absorption member 38 are disposed in a closed cross-section configured by the rocker inner panel and the rocker outer panel.

The first energy absorption member 36 is disposed at an inner side in the vehicle width direction of the rocker 12, and includes a hollow main body portion 40. The main body portion 40 and the cross member 16 are fastened together by a bracket 44. Although not illustrated in the drawings, the other rocker is similarly fastened to the cross member 16 by a bracket, and therefore, the one rocker 12 and the other rocker are connected by a cross member.

The bracket 44 of the present exemplary embodiment is formed in a substantial crank shape when viewed from the vehicle front-rear direction, and an inner side of the bracket 44 in the vehicle width direction is fastened by a fastening means, not illustrated in the drawings, in a state overlapping with the upper face of the cross member 16. An outer side of the bracket 44 in the vehicle width direction is fastened by a bolt 46 in a state overlapped with an upper face of the main body portion 40.

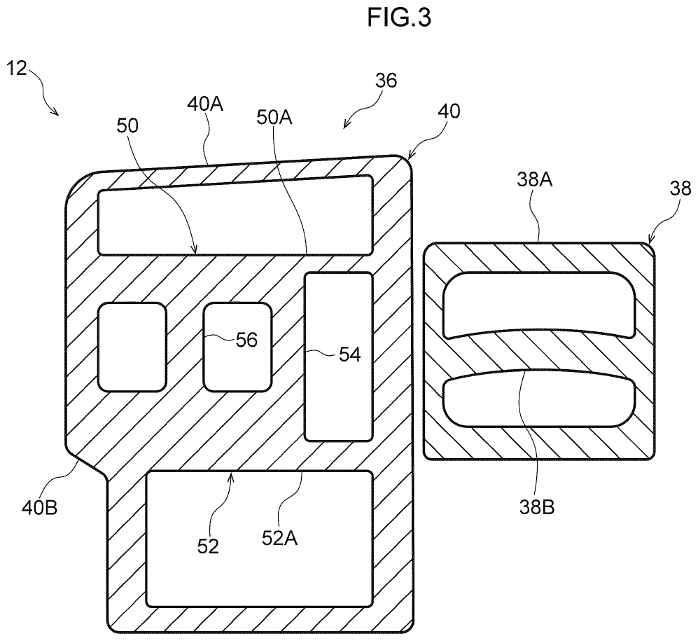

FIG. 3 is an enlarged cross-section of relevant portions illustrating the rocker of FIG. 2 in an enlarged manner. As illustrated in FIG. 3, the upper face of the main body portion 40 is an inclined wall 40A that inclines downward from the vehicle width direction outer side toward the vehicle width direction inner side.

Further, a stepped portion 40B is formed at a side wall at the vehicle width direction inner side of the main body portion 40, and a side above the step portion 40B is positioned further toward the vehicle width direction inner side than a lower side. In other words, the side wall at the vehicle width direction inner side of the main body portion 40 is formed in a shape with a lower portion cut out.

An upper partition wall 50, a lower partition wall 52, an outer side vertical connection wall 54, and an inner side vertical connection wall 56 are provided inside the main body portion 40. Further, a partition portion of the present disclosure is configured including the upper partition wall 50 and the lower partition wall 52.

The upper partition wall 50 is disposed at an upper part of the main body portion 40, and extends in the vehicle width direction such that an outer wall positioned at the vehicle width direction outer side of the main body portion 40 and an inner wall positioned at the vehicle width direction inner side are connected in the vehicle width direction. The internal space of the main body portion 40 is divided into upper and lower parts by the upper partition wall 50. The lower partition wall 52 is disposed lower than the upper partition wall 50, and extends in the vehicle width direction. The internal space of the main body portion 40 is divided into upper and lower parts by the lower partition wall 52.

Here, the upper partition wall 50 is formed with a thicker wall thickness in the vehicle vertical direction at the vehicle width direction inner side than at the vehicle width direction outer side. Specifically, an upper change portion 50A at which the wall thickness changes is formed at a vehicle width direction outer side of a vehicle width direction center portion of the upper partition wall 50. In the present exemplary embodiment, as an example, the wall thickness at the right side of the upper partition wall 50 is set to a thickness of not more than one third of the wall thickness at the left side, with the upper change portion 50A as a boundary.

Similarly to in the upper partition wall 50, the lower partition wall 52 is formed with a thicker wall thickness in the vehicle vertical direction at the vehicle width direction inner side than at the vehicle width direction outer side. Specifically, a lower change portion 52A at which the wall thickness changes is formed at a vehicle width direction outer side of a vehicle width direction center portion of the lower partition wall 52. In the present exemplary embodiment, as an example, the thickness at the right side of the lower partition wall 52 is set to a thickness of not more than one third of the thickness at the left side, with the lower change portion 52A as a boundary. In the present exemplary embodiment, the upper change portion 50A and the lower change portion 52A are formed at positions that overlap each other when viewed from the vehicle vertical direction.

The upper change portion 50A and the lower change portion 52A are connected in the vehicle vertical direction by an outer side vertical connection wall 54. The outer side vertical connection wall 54 extends substantially vertically, and a wall thickness of the outer side vertical connection wall 54 is thicker than a thin portion of the upper partition wall 50, and is formed thinner than a thick portion thereof.

An inner side vertical connection wall 56 is provided further toward the vehicle width direction inner side than the outer side vertical connection wall 54. The inner side vertical connection wall 56 extends substantially parallel to the outer side vertical connection wall 54 in the vehicle vertical direction, and is of the same thickness as the outer side vertical connection wall 54. A space surrounded by the upper side partition wall 50, the lower side partition wall 52, the outer side vertical connection wall 54, and the main body portion 40 is divided into left and right halves by the inner side vertical connection wall 56.

Thus, a space surrounded by the main body portion 40 and the upper partition wall 50 is provided at an upper part of the main body portion 40, and a space surrounded by the main body portion 40 and the lower partition wall 52 is provided at a lower part of the main body portion 40. Further, a space surrounded by the main body portion 40, the upper partition wall 50, and the lower partition wall 52 is provided at a right portion of the main body portion 40.

A second energy absorption member 38 with a closed cross-section structure is provided further toward the vehicle width direction outer side than the main body portion 40. The second energy absorption member 38 includes a hollow main body portion 38A, and an upper-lower partition wall 38B that partitions an internal space of the main body portion 38A into upper and lower parts, and in which a vehicle width direction center portion is curved upward or downward. In the present exemplary embodiment, as an example, the upper-lower partition wall 38B is provided at the vertical direction center portion of the second energy absorption member 38, and a vehicle width direction center portion is curved upward.

Here, the upper wall of the second energy absorption member 38 is disposed at a position that overlaps with the upper partition wall 50 of the first energy absorption member 36 as viewed from the vehicle width direction, and a lower wall of the second energy absorption member 38 is disposed at a position overlapping with the lower partition wall 52 of the first energy absorption member 36 as viewed from the vehicle width direction.

As illustrated in FIG. 2, the upper ridge line of the cross member 16 and the upper partition wall 50 of the first energy absorption member 36 are provided at the same height. In other words, the ridge line of the cross member 16 and the upper partition wall 50 are provided at positions that overlap with each other as viewed from the vehicle width direction. Here, the ridge line of the cross member 16 refers to a portion between the upper face and the front face of the cross member 16, and a portion between the upper face and the rear face of the cross member 16.

Further, a position of the flange 16A at the lower end of the cross member 16 and the lower partition wall 52 of the first energy absorption member 36 are disposed at the same height. In other words, the lower end of the cross member 16 and the lower partition wall 52 are provided at positions that overlap with each other when viewed from the vehicle width direction.

In addition, the outer side vertical connection wall 54 is provided at the vehicle width direction outer side of a center line CL of the fastening portion between the battery case 14 and the first energy absorption member 36. In other words, a fastening hole for fastening the battery case 14 and the rocker 12 is provided further toward the vehicle width direction inner side than the outer side vertical connection wall 54.

Explanation follows regarding the mechanism of the vehicle framework structure according to the present exemplary embodiment.

The vehicle 10 to which the vehicle framework structure according to the present exemplary embodiment is applied has the rocker 12 including the hollow main body portion 40 and partitioning parts (the upper partition wall 50 and the lower partition wall 52), and the main body portion 40 is provided at a vehicle width direction end portion and extends in the vehicle front-rear direction. The upper partition wall 50 and the lower partition wall 52, which are partitioning parts, are provided inside the main body portion 40, and the internal space of the main body portion 40 is divided into upper and lower parts by the upper partition wall 50 and the lower partition wall 52. Here, the upper side partition wall 50 connects the outer wall positioned at the vehicle width direction outer side, and the inner wall positioned at the vehicle width direction inner side, of the main body portion 40 in the vehicle width direction. As a result, a collision load input to the outer wall during a side-on collision of the vehicle 10 is transmitted to the inner wall via the upper partition wall 50. Similarly, the lower partition wall 52 connects the outer wall positioned at the vehicle width direction outer side, and the inner wall positioned at the vehicle width direction inner side, of the main body portion 40 in the vehicle width direction. As a result, a collision load input to the outer wall during a side-on collision of the vehicle 10 is transmitted to the inner wall via the lower partition wall 52.

Since the upper partition wall 50 and the lower partition wall 52 are formed with a thicker wall thickness in the vehicle vertical direction at the vehicle width direction inner side than at the vehicle width direction outer side, the vehicle width direction outer side, which is relatively thin, can collapse and absorb collision energy. However, as a result of the thicker vehicle width direction inner side portions of the upper partition wall 50 and the lower partition wall 52 bending and changing without collapsing, local deformation of the rocker 12 can be suppressed.

Further, in the present exemplary embodiment, as illustrated in FIG. 3, the upper partition wall 50 is provided with the upper change portion 50A, at which the wall thickness changes, further toward the vehicle width direction outer side than the vehicle width direction center portion, and the lower change portion 52A, at which the wall thickness changes further toward the vehicle width direction outer side than the vehicle width direction center portion, is provided at the lower partition wall 52. The upper change portion 50A and the lower change portion 52A are connected by the outer side vertical connection wall 54 extending in the vehicle vertical direction. This enables the regions as far as the upper change portion 50A and the lower change portion 52A to be effectively collapsed and absorb collision energy, while connecting the upper change portion 50A and the lower change portion 52A with the outer side vertical connection wall 54 enables the collision load to be distributed.

Further yet, in the present exemplary embodiment, as illustrated in FIG. 1, the rocker 12 at one vehicle width direction side and the rocker 12 at the other vehicle width direction side are connected by a cross member 16. As illustrated in FIG. 2, the ridgeline of the cross member 16 is provided at the same height as the upper partition wall 50 of the first energy absorption member 36, and therefore, a collision load input to the first energy absorption member 36 at the time of a side-on collision is transmitted to the ridge line of the cross member 16 via the upper partition wall 50. This enables a collision load to be effectively transmitted to the non-collision side, and enables deformation of the vehicle body to be suppressed.

Further, in the present exemplary embodiment, since the lower end of the cross member 16 is attached to the battery case 14, compared to a structure in which the upper face of the battery case 14 is used as a floor panel and a dedicated floor panel is provided, a wider installation space for the battery BT can be secured. Further, because the lower end of the cross member 16 and the lower partition wall 52 of the first energy absorption member 36 are at the same height, a collision load is transmitted to a lower end of the cross member 16 via the lower partition wall 52.

Further, in the present exemplary embodiment, since fastening holes (fastening portions) that fasten the first energy absorption member 36 (the rocker 12) to the battery case 14 are provided further toward the vehicle width direction inner side than the outer side vertical connection wall 54, at the time of a side-on collision, the fastening portions between the rocker 12 and the battery case 14 can be protected.

Further yet, in the present exemplary embodiment, a second energy absorption member 38 with a closed cross-section structure is provided further toward the vehicle width direction outer side than the main body portion 40, and the second energy absorption member 38 is provided with an upper-lower partition wall 38B that partitions an internal space into upper and lower parts, and has a vehicle width direction center portion that is curved upward or downward. As a result, in a side-on collision, the second energy absorption member 38 is sandwiched between a barrier and the first energy absorption member 36, and because the upper-lower partition wall 38B folds and is deformed upward, part of the collision energy can be absorbed before the barrier enters the first energy absorption member 36.

Further, in the present exemplary embodiment, since, as illustrated in FIG. 3, the upper face of the main body portion 40 is an inclined wall 40A tilted downward from the vehicle width direction outer side toward the vehicle width direction inner side, compared to a structure in which the upper face of the main body portion 40 extends substantially horizontally, a collision load is more easily transmitted to the cross member 16. This enables a collision load to be effectively transmitted to the non-collision side.

Although a vehicle framework structure according to the present disclosure has been described above, it is, of course, the case that various embodiments can be practiced within a range that does not depart from the gist of the present disclosure. For example, in the present exemplary embodiment, the rocker 12 is configured including the first energy absorption member 36 and the second energy absorption member 38; however, there is no limitation to this, and the configuration may be such that only the first energy absorption member 36 is provided.

Further, in the present exemplary embodiment, the first energy absorption member 36 includes the outer side vertical connection wall 54 and the inner side vertical connection wall 56; however, there is no limitation to this, and the configuration may be such that only the outer side vertical connection wall 54 is provided.

Further, in the present exemplary embodiment, the main body portion 40 of the first energy absorption member 36 is configured including the stepped portion 40B; however, there is no limitation to this, and the configuration may be such that the stepped portion 40B is not provided. Further yet, in the present exemplary embodiment, the configuration is such that the battery case 14 is provided under the floor of the vehicle 10; however, there is no limitation to this. For example, the present disclosure may be applied to a vehicle in which a battery is not installed.

In relation to the exemplary embodiments described above, the following additional notes are disclosed.

### (Additional Note 1)

A vehicle framework structure, including a framework member including:
a hollow main body portion provided at a vehicle width direction end part and extending in a vehicle front-rear direction; and
a partition part provided inside the main body portion and dividing an internal space of the main body portion into upper and lower parts,
in which the partition part in the framework member connects an outer wall positioned at a vehicle width direction outer side, and an inner wall positioned at a vehicle width direction inner side, of the main body portion, and a vehicle width direction inner side of the partition part is formed with a greater thickness in a vehicle vertical direction than a vehicle width direction outer side of the partition part.

### (Additional Note 2)

The vehicle framework structure of additional note 1, in which:
the partition part includes an upper partition wall disposed at an upper part of the main body portion and a lower partition wall disposed at a lower part of the main body portion,
the upper partition wall and the lower partition wall are provided with a change part, at which the thickness changes, further toward the vehicle width direction outer side than a vehicle width central part, and
the change part of the upper partition wall and the change part of the lower partition wall are connected by a vertical connection wall extending in the vehicle vertical direction.

### (Additional Note 3)

The vehicle framework structure of additional note 2, in which:
the framework member is provided at respective vehicle width direction sides of a vehicle,
one of the framework members and another of the framework members are connected by a cross member extending in the vehicle width direction, and
a ridge line of the cross member is provided at the same height as the upper partition wall.

### (Additional Note 4)

The vehicle framework structure of additional note 3, in which:
a lower end of the cross member is attached to a battery case housing a battery, and
the lower end of the cross member and the lower partition wall are disposed at the same height.

### (Additional Note 5)

The vehicle framework structure of additional note 4, in which:
a fastening hole at which the battery case is fastened is formed at the framework member, and
the fastening hole is provided further toward the vehicle width direction inner side than the vertical connection wall.

### (Additional Note 6)

The vehicle framework structure of any one of additional notes 1 to 5, in which:
an energy absorption member with a closed cross-section structure is provided further toward the vehicle width direction outer side than the main body portion, and
the energy absorption member is provided with an upper-lower partition wall that partitions an internal space into upper and lower parts and that has a vehicle width direction center part that is curved upward or downward.

### (Additional Note 7)

The vehicle framework structure of any one of additional notes 1 to 6, in which an upper surface of the main body portion is inclined downward from a vehicle width direction outer side toward a vehicle width direction inner side.

What is claimed is:

1. A vehicle framework structure, including a framework member including:
a hollow main body portion provided at a vehicle width direction end part and extending in a vehicle front-rear direction; and
a partition part provided inside the main body portion and dividing an internal space of the main body portion into upper and lower parts,
wherein the partition part connects an outer wall positioned at a vehicle width direction outer side, and an inner wall positioned at a vehicle width direction inner side, of the main body portion, and a vehicle width direction inner side of the partition part is formed with a greater thickness in a vehicle vertical direction than a vehicle width direction outer side of the partition part.

2. The vehicle framework structure of claim 1, wherein:
the partition part includes an upper partition wall disposed at an upper part of the main body portion and a lower partition wall disposed at a lower part of the main body portion,
the upper partition wall and the lower partition wall are provided with a change part, at which the thickness changes further toward the vehicle width direction outer side than a vehicle width central part, and
the change part of the upper partition wall and the change part of the lower partition wall are connected by a vertical connection wall extending in the vehicle vertical direction.

3. The vehicle framework structure of claim 2, wherein:
the framework member is provided at respective vehicle width direction sides of a vehicle,
one of the framework members and another of the framework members are connected by a cross member extending in the vehicle width direction, and
a ridge line of the cross member is provided at the same height as the upper partition wall.

4. The vehicle framework structure of claim 3, wherein:
a lower end of the cross member is attached to a battery case housing a battery, and
the lower end of the cross member and the lower partition wall are disposed at the same height.

5. The vehicle framework structure of claim 4, wherein:
a fastening hole at which the battery case is fastened is formed at the framework member, and
the fastening hole is provided further toward the vehicle width direction inner side than the vertical connection wall.

6. The vehicle framework structure of claim 1, wherein:
an energy absorption member with a closed cross-section structure is provided further toward the vehicle width direction outer side than the main body portion, and
the energy absorption member is provided with an upper-lower partition wall that partitions an internal space into upper and lower parts and that has a vehicle width direction center part that is curved upward or downward.

7. The vehicle framework structure of claim 1, wherein an upper surface of the main body portion is inclined downward from a vehicle width direction outer side toward a vehicle width direction inner side.
